(19) United States
(12) Patent Application Publication
(10) Pub. No.: US 2006/0106124 A1
(43) Pub. Date: May 18, 2006

(54) Viscoelastic rebond polyurethane foam structure

(75) Inventors: John T. Fink, Villanova, PA (US); George O. De La Garza, Carrollton, TX (US); John R. Rucker, Oxford, PA (US); Beat B. Niederoest, Medford Lakes, NJ (US); Stephen Drap, Thornton, PA (US)

Correspondence Address: CONNOLLY BOVE LODGE & HUTZ, LLP, P O BOX 2207, WILMINGTON, DE, 19899, US

(73) Assignee: FOAMEX L.P., Linwood, PA (US)

(21) Appl. No.: 10/986,674

(22) Filed: Nov. 12, 2004

(51) Int. Cl. C08G 18/00

(52) U.S. Cl. 521/172

(57) ABSTRACT

A rebond polyurethane foam structure is formed by mixing shredded particles of polyurethane foam wherein at least 20% by weight of such particles comprise particles of viscoelastic polyurethane foam. The foam particles are wetted with a liquid prepolymer binder that is cured when the wetted admixture is compressed at a compression ratio of at least about 3. Despite the small viscoelastic foam particle size and the effects of compression and binder curing, the resulting polyurethane foam structure surprisingly has a viscoelastic (slow recovery) character.

### BACKGROUND OF THE INVENTION

1. Field of the Invention

The invention relates to a rebond polyurethane foam structure obtained by mixing together particles of polyurethane foam, wetting the mixture with a liquid prepolymer binder and curing the binder under compression, preferably with steam. More specifically, a percentage of the polyurethane foam particles are viscoelastic or slow recovery foam.

2. Description of the Related Technology

Polyurethane foams are prepared by reacting, in the presence of a blowing agent, polyisocyanates with one or more high molecular weight polyols. Usually catalysts, such as organotin compounds and tertiary amines, and emulsifiers, such as silicone oils, are incorporated into the reaction mixture to control reaction rate, cell size and porosity.

Polyurethane foams are widely used in the construction of bedding, particularly mattresses and mattress toppers or pads. Bedding constructions that include viscoelastic foams have become very popular not only for medical and orthopedic applications, but also for home use. Viscoelastic foams exhibit slower recovery when a compression force is released than do other resilient polyurethane foams. For example, after being released from compression, a resilient polyurethane foam at room temperature, atmospheric condition generally recovers to its full uncompressed height or thickness in one second or less. By contrast, a viscoelastic foam of the same density and thickness, and at the same room temperature condition, will take significantly longer to recover, even from two to sixty seconds. The recovery time of viscoelastic foams is sensitive to temperature changes within a range close to standard room temperature. Slow recovery foams also exhibit ball rebound values of generally less than about 20% as compared to about 40% or more for other foams.

A precise definition of a viscoelastic foam is derived by a dynamic mechanical analysis to measure the glass transition temperature (Tg) of the foam. Nonviscoelastic resilient polyurethane foams, based on a 3000 molecular weight polyether triol, generally have glass transition temperatures below −30 C, and possibly even below −50 C. By contrast, viscoelastic polyurethane foams have glass transition temperatures above −20 C. If the foam has a glass transition temperature above 0 C, or closer to room temperature (e.g. room temperature=about +20 C), the foam will manifest more viscoelastic character (i.e., slower recovery from compression) if all other parameters are held constant.

As the market for viscoelastic polyurethane foam continues to grow for use in the bedding industry, the amount of viscoelastic foam scrap is also increasing. Economical and practical alternate uses for this foam scrap continue to be sought.

A substantial portion of carpet cushion comprises a rebond foam structure formed from recycled polyurethane foam scrap. The foam scrap is ground or shredded to particle sizes generally from ⅜ to ¾ inch (0.95 to 1.91 cm), the particles are mixed together and wetted with a prepolymer binder, the wetted mixture is then compressed and the binder is cured, usually with steam or applied heat. The resulting rebond foam structure is then sliced to a desired product thickness to form carpet cushion or flooring underlayment. Frequently, the sheet of rebond foam structure is laminated to a woven or nonwoven scrim or a polymeric sheet, such as with a pressure-sensitive or hot melt adhesive or by flame lamination.

In addition to carpet cushion, rebond foam structures also have been used for auto floor mats, gym mats and other sporting goods. If special molds are used, the rebond foam structure can form more complex-shaped products, such as automotive seating.

Most rebond foam sold commercially has a density in the range of 3.5 to 8 pounds per cubic foot (56.1 to 128.1 kg/m³).

A rebond foam structure with viscoelastic properties (a slower recovery from compression) is desired for many of these rebond applications. Such a structure that makes use of viscoelastic foam scrap has environmental and economic advantages. A rebond foam structure with a higher density is also desired.

### SUMMARY OF THE INVENTION

A rebond polyurethane foam structure is formed to contain at least 20% by weight of viscoelastic polyurethane foam particles. Such structure is formed by mixing together viscoelastic polyurethane foam particles, optionally with other foam particles and scrap materials. The mixture containing foam particles is wetted with a liquid prepolymer binder, preferably in an amount of at least from about 15% by weight, based on 100% by weight of the foam particles plus binder. The wetted admixture is compressed to a compression ratio of at least about 3, and then the binder is cured with heat or steam to form the rebond polyurethane foam structure. The resulting rebond polyurethane foam structure preferably has a density in the range of from 5 to 25 pounds per cubic foot (80.1 to 400.5 kg/m³), and a hysteresis above about 65% when measured at 15 in/min (38.1 cm/min). Despite the small viscoelastic foam particle size and the effects of compression and binder curing, the resulting rebond polyurethane foam structure surprisingly has a viscoelastic (slow recovery) character.

The viscoelastic polyurethane foam particles may be present in the mixture from 20% and up to 100% by weight. The foam particles preferably have a mean particle size of ½ inch (1.27 cm) and below. More commonly the rebond is formed from recycled materials, and the foam particle mixture will contain other polyurethane foam particles, and optionally comminuted scrap materials, such as plastics, textiles and fibers.

The rebond polyurethane foam structure according to the invention may be used to form carpet cushion and flooring underlayment, and also can be incorporated into other products that customarily include rebond foam structures.

Other aspects and advantages will be apparent from the following description given hereinafter referring to the attached drawings.

### DESCRIPTION OF THE DRAWINGS

FIG. 1 is a graph illustrating the hysteresis behavior of a viscoelastic rebond foam structure according to the invention as compared to conventional rebond foam structures;

FIG. 2 is a graph illustrating the compression force deflection (CFD₂₅) of a viscoelastic rebond foam structure according to the invention as compared to conventional rebond foam structures; and

FIG. 3 is a graph illustrating that a viscoelastic rebond foam structure according to the invention retained its thickness after 12,000 roller shear fatigue cycles as well as did a conventional rebond foam structure.

### DETAILED DESCRIPTION OF PREFERRED EMBODIMENTS

Rebond polyurethane foam structures are formed by providing a mixture of particles of polyurethane foam; wetting the foam particles with a liquid prepolymer binder; compressing the wetted admixture to a desired compression ratio; and curing the binder with heat or steam to form the rebond polyurethane foam structure. According to the invention, a substantial portion of the foam particles comprise viscoelastic polyurethane foam. Preferably, at least 20% by weight of the foam particles are viscoelastic polyurethane foam, more preferably at least 50% by weight, and most preferably at least 70% by weight. It is within the scope of this invention to use 100% foam particles that are viscoelastic polyurethane foam.

Examples of methods for making a viscoelastic foam are set out in U.S. Pat. Nos. 6,653,363 and 6,734,220. The viscoelastic foams exhibit slow recovery, and preferably have glass transition temperatures of −20 C and above. Viscoelastic foam densities generally range from 2.5 pounds per cubic foot to 6.5 pounds per cubic foot (40 to 104.1 kg/m³).

The viscoelastic foam particles used to form the rebond foam structures of the invention preferably have a mean particle size of ½ inch (1.27 cm) and below, preferably in the range of from ⅛ to ½ inch (0.32 to 1.27 cm), most preferably below 3/16 inch (0.48 cm). By “mean particle size” is meant that the average diameter of the particles is within the stated range. Although some foam particles in the mixture will have particle sizes higher and lower than the mean particle size, preferably a predominant portion fall within the stated range. We intend to use viscoelastic foam particles cut to a smaller particle size than is otherwise customary for rebond foam constructions made with other than viscoelastic foam particles. The viscoelastic foam particles are irregularly shaped, and particle shape uniformity is not required to form a rebond foam structure.

The foam particles are wetted with a liquid prepolymer binder. Liquid prepolymer binder compositions are known to persons skilled in the art. See, e.g., U.S. Pat. No. 4,082,703. Preferably, such binders contain one or more polyols and one or more isocyanates. Polyols are generally classified as polyether polyols or polyester polyols. Polyether polyols are conventionally oxides, such as ethylene oxide or propylene oxide, polymerized onto an active hydrogen compound, such as ethylene glycol, propylene glycol, glycerol, and so forth. Polyester polyols are conventionally polycondensation products of polyhydric acids, such as adipic acid, maleic acid or phathalic acid, with polyhydroxy compounds, such as ethylene glycol, propylene glycol, glycerol, and so forth.

Isoycanates include TDI (toluene diisocyanate) or MDI (methylene diphenyl diisocyanate) or PMDI (polymeric MDI or diphenylmethane diisocyanate containing methylene biphenyl isocyanate and/or polymethylene polyphenyl isocyanate).

A particularly preferred liquid prepolymer binder is a pre-blended mix incorporating MDI, polyol, and process oil. The calculated free NCO % of this preferred binder is about 10.5%. As one example, we have used a binder formulation with about 38% by weight MDI, 30% by weight polyol, and 32% by weight process oil, where the MDI was RUBINATE 9471 from Huntsman Polyurethanes, the polyol was a polyether polyol known as ARCOL 3222 from Bayer Material Science, and the process oil was a silicone based oil known as 330-LN from Golden Bear.

The liquid prepolymer binder is used in amounts greater than commonly used for rebond structures made with other than viscoelastic foam particles. Preferably, at least 15% by weight of liquid binder (based on the weight percentage of the foam particles and binder) is used to wet the foam particles.

The wetted mixture is then placed into a mold and compressed to a compression ratio of at least about 3. By “compression ratio of 3” is meant that a mixture is compressed to one third of its original thickness in the mold. A “compression ratio of 5” means that a mixture is compressed to a greater extent or to one fifth its original thickness in the mold. We have found that higher compression ratios help coalesce the foam particles together in the mold. The higher compression ratios also result in a rebond structure with a higher density.

The binder is cured after the wetted mixture is compressed in the mold. Preferably, the binder is cured by heating the mold or by passing steam through the mold. Heating or steam times can vary, but typically range from 3 to 6 minutes.

The matrix of foam particles and cured binder removed from the mold constitutes the rebond foam structure. This structure is removed from the mold, and sliced or shaped to form a desired end product. For carpet cushion and flooring underlayment, usually a cylindrical molded matrix is formed. After de-molding, the cylindrical molded matrix is placed on a mandrel of cutting tool that rotates the cylinder and cuts material away from the outer cylindrical circumference with a blade. The blade thus slices or peels a continuous sheet of rebond foam structure from the matrix. This sheet may then be laminated to a supporting web or film to form a carpet cushion. Known laminating methods include pressure sensitive adhesive, hot melt adhesive film, hot roll lamination and flame lamination (e.g., heating a surface of the rebond structure to soften or tackify the foam/binder either before or while the rebond structure and web or film are presented to the nip between compression rollers). Example supporting webs include woven or nonwoven fibers or polymeric films. An example scrim is a polypropylene scrim with a weight of 4.5 g/yd² having a 6 mm by 6 mm mesh pattern. This scrim is available from Conwed.

The rebond foam structure has a density in the range of from 5 to 25 pounds per cubic foot (80.1 to 400.5 kg/m³), preferably from 10 to 20 pounds per cubic foot (160.2 to 320.4 kg/m³).

Optionally, the foam particle mixture may contain scrap materials, including polyether polyurethane foam, polyester polyurethane foam, textile fibers, or other types of thermoset foams and plastics. Preferably, such scrap materials are cut to have particle sizes comparable to the particle sizes of the viscoelastic foam in the composition, and constitute a minor portion of the rebond composition.

### EXAMPLES

Rebond foam structures were produced with varying formulations as set out in Table 1 below. In all examples, the binder was a pre-blended mixture incorporating 38% by weight MDI, 30% by weight polyol, and 32% by weight process oil, where the MDI was RUBINATE 9471 from Huntsman Polyurethanes, the polyol was a polyether polyol known as ARCOL 3222 from Bayer Material Science, and the process oil was a silicone based oil known as 330-LN from Golden Bear. In one of the comparative examples, the formulation included other scrap materials as set forth in Table 1.

TABLE 1

| | Component | | | | |
|---|---|---|---|---|---|
| | average | | | | |
| Component | density (pcf) | Ex. A | Ex. B | Ex. C | Ex. 1 |
| Polyether foam I | 1.5 | 100% | 13.4% | 5.2% | 30.0% |
| Polyether foam II | 2.0 | — | 40.3% | 24.4% | — |
| Reground | 5.7 | — | 32.9% | 38.2% | — |
| rebond | | | | | |
| Fabric Trim | 2.7 | — | 13.4% | 32.2% | — |
| Viscoelastic | 3.7 | — | — | — | 70.0% |
| foam | | | | | |
| Binder (as % of | | 9.6% | 9.6% | 9.6% | 15% |
| component + | | | | | |
| binder) | | | | | |
| Average | | 2.3 | 1.9 | 2.2 | 3.3 |
| Compression | | | | | |
| ratio | | | | | |
| Rebond density | | 3.5 | 6 | 8 | 10 |
| (pcf) | | | | | |

Polyether foam I comprised a 1.5 pound per cubic foot density (24.0 kg/m³) foam, sourced from foam scraps. Polyether foam II comprised a 2.0 pound per cubic foot (32.0 kg/m³) density foam sourced from foam scraps. The densities are stated as averages since some of the scrap foams had densities different from the reported density.

The reground rebond was a scrap product consisting primarily of polyether polyurethane foam rebond. The average density was 5.7 pounds per cubic foot (91.2 kg/m³).

The viscoelastic foam was also scrap product consisting primarily of viscoelastic foams with an average density of 3.7 pound per cubic foot (59.3 kg/m³).

Fabric Trim comprised comminuted woven textile fibers from recycled automotive trim and mattress components.

Example 1 formed a rebond foam structure according to the invention. Examples A to C are comparative examples of varying densities that did not include any viscoelastic foam particles.

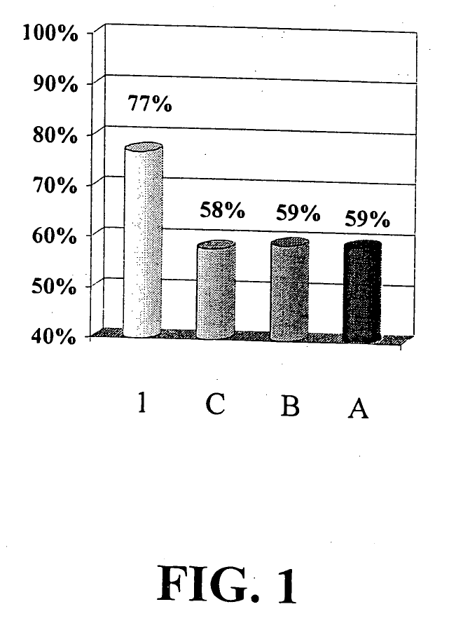

Despite comminuting the viscoelastic foam into small particles of ⅛ to ½ inch (0.32 to 1.27 cm) in diameter and including a substantial amount of cured binder, the viscoelastic rebond structure retained its slow recovery or hysteresis. Hysteresis is a measurement of the energy absorbed by a foam when subjected to a deformation. To calculate hysteresis, each rebond sample was compressed to 80% deflection and then allowed to return to its uncompressed state. A stress/strain curve was generated. The area under the compression curve is numerically integrated, as is the area under the de-compression curve. The hysteresis % is calculated as: (area under compression curve) minus (area under de-compression curve) divided by (area under compression curve). This hysteresis % is the percent of the original energy imparted to the sample by the unit that is lost in the form of heat during the compression cycle that is not returned to the load cell. In this test, the hysteresis measurement was performed using a crosshead speed of 15 in/min (38.1 cm/min). As shown in FIG. 1, the hysteresis for Example 1 rebond was 77%, whereas the other rebond structures of Examples A to C were 58% and 59%.

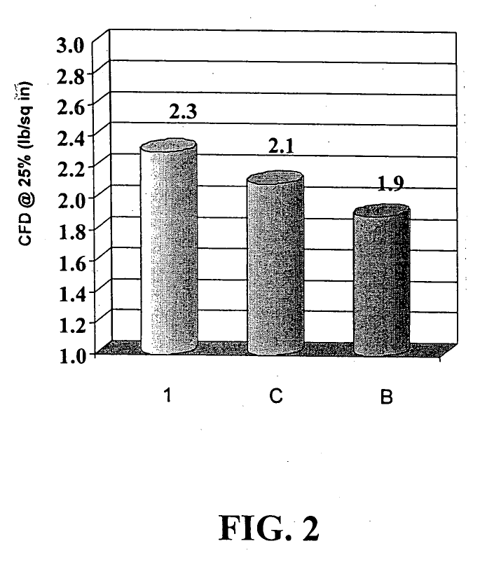

Despite the starting softness of the viscoelastic foam scrap, which was measured as between 8 to 16 IFD₂₅ using the measuring method set out in ASTM 3574, the foam retained firmness to a level desired for rebond foam structures. As set out in FIG. 2, the compression force deflection (CFD₂₅) of the viscoelastic rebond was 2.3 psi (0.16 kg/m²). Comparative rebonds of Examples B and C had CFD₂₅ of 1.9 and 2.1 psi (0.13 to 0.15 kg/cm²), respectively. The CFD₂₅ would be expected to be increased by the increased density of the rebond structure for rebond formed without viscoelastic foam particles. That the CFD₂₅ increased linearly even with the viscoelastic foam particles in the rebond structure of Example 1 was surprising.

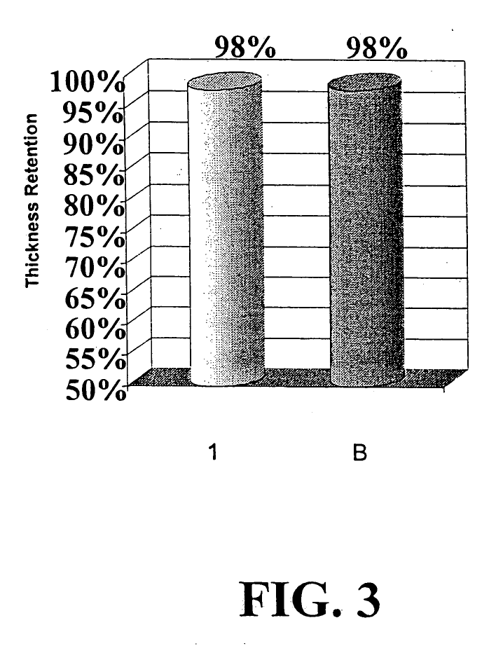

That the viscoelastic rebond structure retains its total height over time despite containing a substantial portion of softer viscoelastic foam particles in the foam particle mixture is also demonstrated in FIG. 3. Example B and Example 1 were tested with a roller shear fatigue test to replicate performance for a carpet cushion. Cycling was conducting between two nip rollers, one operating at 45 feet per minute (13.7 m/min) and the other operating at 43 feet per minute (13.1 m/min). The differential speed was used to impart shear to a sample simultaneously with compression, as would be the case for walking motions over a carpet/carpet cushion. The compression ratio was in this case approximately 46% during each compression cycle. The compression ratio for the test is preselected based on the firmness of the rebond sample and the degree to which the sample would be expected to compress when walked upon by an average person. For the samples tested, an 8.3 psi (0.58 kg/cm²) load was applied and the deflection was measured to determine the compression ratio for the cycle testing. The samples were subjected to 12,000 roller shear cycles. Both rebond samples maintained 98% of their original thickness after this test.

In addition, and surprisingly, the viscoelastic rebond structure of the invention exhibits greater sound absorption than other rebond structures of equivalent density when tested under ASTM E1050. The sound absorption coefficient α (ratio of energy absorbed by the surface to the energy incident upon the surface) as a function of frequency is higher for sound frequencies between 1000 Hz and 5000 Hz for the viscoelastic rebond foam structure according to the invention.

Numerous characteristics and advantages have been set forth in the foregoing description, together with detail of structure and function. The novel features are pointed out in the appended claims. The disclosure, however, is illustrative only, and changes may be made in detail, especially in matters of size, shape, and arrangement of parts, within the principle of the invention, to the full extent indicated by the broad general meaning of the terms in which the appended claims are expressed. Therefore, the invention must be measured by the claims and not by the description of the examples or the preferred embodiments.

We claim:

1. A rebond polyurethane foam structure obtained from the steps of:
(a) providing a mixture of particles of polyurethane foam wherein at least 20% by weight of such particles comprise particles of viscoelastic polyurethane foam;
(b) wetting the foam particles with a liquid prepolymer binder;
(c) compressing the wetted admixture to a compression ratio of at least about 3;
(d) curing the binder with heat or steam to form the rebond polyurethane foam structure.

2. The rebond polyurethane foam structure of claim 1, wherein at least 50% by weight of the foam particles are viscoelastic polyurethane foam particles.

3. The rebond polyurethane foam structure of claim 1, wherein at least 70% by weight of the foam particles are viscoelastic polyurethane foam particles.

4. The rebond polyurethane foam structure of claim 1, wherein 100% by weight of the foam particles are viscoelastic polyurethane foam particles.

5. The rebond polyurethane foam structure of claim 1, wherein the mixture contains scrap materials selected from the group consisting of: polyether polyurethane foam, polyester polyurethane foam, plastics and fibers.

6. The rebond polyurethane foam structure of claim 1, wherein the liquid prepolymer binder is added to the particles in an amount of at least from about 15% by weight, based on 100% by weight of the foam particles plus binder.

7. The rebond polyurethane foam structure of claim 1, wherein the resulting rebond polyurethane foam structure has a density in the range of from 5 to 25 pounds per cubic foot (80.1 to 400.5 kg/m³).

8. The rebond polyurethane foam structure of claim 1, wherein the resulting rebond polyurethane foam structure has a density in the range of from 10 to 20 pounds per cubic foot (160.2 to 320.4 kg/m³).

9. The rebond polyurethane foam structure of claim 1, wherein the viscoelastic foam particles have a mean particle size diameter of 3/16 inch (0.48 cm) or below.

10. The rebond polyurethane foam structure of claim 1, wherein the viscoelastic foam particles have a mean particle size diameter of ⅛ inch (0.16 cm) or below.

11. The rebond polyurethane foam structure of claim 1, wherein the binder comprises at least one reactive polyol and at least one reactive isocyanate.

12. A method for forming a rebond polyurethane foam structure, comprising:
(a) providing a mixture of particles of polyurethane foam wherein at least 20% by weight of such particles comprise particles of viscoelastic polyurethane foam;
(b) wetting the foam particles with a liquid prepolymer binder;
(c) compressing the wetted admixture to a compression ratio of at least about 3;
(d) curing the binder with heat or steam to form the rebond polyurethane foam structure.

13. The method of claim 12, wherein at least 50% by weight of the foam particles are viscoelastic polyurethane foam particles.

14. The method of claim 12, wherein at least 70% by weight of the foam particles are viscoelastic polyurethane foam particles.

15. The method of claim 12, wherein 100% by weight of the foam particles are viscoelastic polyurethane foam particles.

16. The method of claim 12, wherein the mixture contains scrap materials selected from the group consisting of: polyether polyurethane foam, polyester polyurethane foam, plastics and fibers.

17. The method of claim 12; wherein the resulting rebond polyurethane foam structure has a density in the range of from 5 to 25 pounds per cubic foot (80.1 to 400.5 kg/m³).

18. The method of claim 12, wherein the resulting rebond polyurethane foam structure has a density in the range of from 10 to 20 pounds per cubic foot (160.2 to 320.4 kg/m³).

19. The method of claim 12, wherein the foam particles have a mean particle size diameter of 3/16 inch (0.48 cm) or below.

20. The method of claim 12, wherein the foam particles have a mean particle size diameter of ⅛ inch (0.16 cm) or below.

21. The method of claim 12, wherein the liquid prepolymer binder is added in an amount of at least from about 15% by weight, based on 100% by weight of the foam particles plus binder.

22. The method of claim 12, wherein the binder comprises at least one reactive polyol and at least one reactive isocyanate.

23. A carpet cushion or floor underlayment comprising a rebond polyurethane foam structure of claim 1.

24. A carpet cushion or floor underlayment comprising a rebond polyurethane foam structure made by the method of claim 12.

25. A rebond polyurethane foam structure, comprising:
a matrix of foam particles and optional other scrap material bound under compression with a cured binder, wherein at least 20% by weight, based on the weight of the foam particles, constitute viscoelastic foam particles, and wherein said matrix has a density of at least 10 pounds per cubic foot (160.2 kg/m³) and a hysteresis above about 65%.

26. The rebond polyurethane foam structure of claim 25, wherein at least 50% by weight of the foam particles constitute viscoelastic foam particles.

27. The rebond polyurethane foam structure of claim 25, wherein at least 70% by weight of the foam particles constitute viscoelastic foam particles.

28. The rebond polyurethane foam structure of claim 25, wherein the foam particles comprise in part particles of nonviscoelastic resilient polyether or polyester polyurethane foam.

29. The rebond polyurethane foam structure of claim 25, wherein the scrap material is present and is one or more materials selected from the group consisting of: plastics, textiles and fibers.

30. A carpet cushion or floor underlayment incorporating the rebond polyurethane foam structure of claim 25.
